(19) United States
(12) Patent Application Publication
(10) Pub. No.: US 2005/0248307 A1
(43) Pub. Date: Nov. 10, 2005

(54) Method for controlling induction motor

(75) Inventor: Shoji Okado, Ama-gun (JP)

Correspondence Address: BROWDY AND NEIMARK, P.L.L.C.;624 NINTH STREET, NW, SUITE 300, WASHINGTON, DC, 20001-5303, US

(73) Assignee: Kabushiki Kaisha Meiki Seisakusho, Ohbu-shi (JP)

(21) Appl. No.: 11/115,259

(22) Filed: Apr. 27, 2005

(30) Foreign Application Priority Data
May 7, 2004 (JP) 2004-137969

(51) Int. Cl. H02P 7/36

(52) U.S. Cl. 318/799

(57) ABSTRACT

In a method for controlling an induction motor 14, in which the speed of the induction motor 14 is controlled, by an inverter 21, to move and stop an actuator 22 at a predetermined position, a speed command 23 to be input to the inverter 21 is switched to an intermittent pulse signal 27 when the actuator 22 reaches a position B, a predetermined distance before, the predetermined position C. Thus, the system can be constructed at low cost, and sufficient practical positioning and stopping accuracy can be easily obtained.

### BACKGROUND OF THE INVENTION

1. Field of the Invention

The present invention relates to a positioning control for an actuator using an induction motor.

2. Description of Related Art

Japanese Unexamined Patent Publication (Kokai) No. 2001-175334 discloses a conventional position control system in which an induction motor and an inverter are combined as described in detail in Paragraphs [0002] to [0017] and shown in FIGS. 7 to 10.

A load position control speed disclosed in Japanese Unexamined Patent Publication (Kokai) No. 2001-175334 is as follows. An absolute position detector 26 outputs an absolute position signal in accordance with a position of a movable table driven by an induction motor 21. In a position controller 27, there are provided an absolute signal converter 35 which supplies absolute position data produced based on the absolute position signal, to control a position of a movable table; and a pulse train output converter 36 which supplies, as a speed feedback pulse for the induction motor 21, an incremental pulse produced based on the absolute position signal, to a vector control inverter 29.

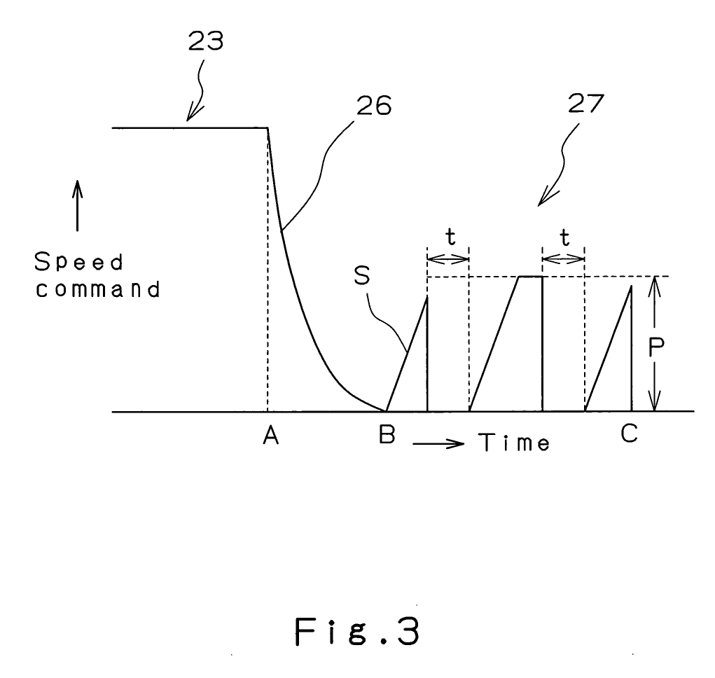

As described above, a conventional system shown in FIGS. 7 and 8 of Japanese Unexamined Patent Publication (Kokai) No. 2001-175334 is of open-loop control type and, accordingly, can be constructed at low cost. However, a speed reduction control is not effective for positioning and, accordingly, positioning and stopping accuracy is reduced. Contrary to this, another conventional system shown in FIGS. 9 and 10 of Japanese Unexamined Patent Publication (Kokai) No. 2001-175334 is of closed-loop control type and, accordingly, positioning and stopping accuracy is improved, but the system is expensive. Moreover, a system disclosed in Japanese Unexamined Patent Publication (Kokai) No. 2001-175334 has a complicated structure and is more expensive.

### BRIEF SUMMARY OF THE INVENTION

The present invention provides a method for controlling an induction motor, in which the speed of the induction motor is controlled, by an inverter, to move and stop an actuator at a predetermined position, wherein a speed command to be input to the inverter is switched to an intermittent pulse signal when the actuator reaches a position, a predetermined distance before the predetermined position. Thus, the system can be constructed at low cost, and sufficient practical positioning and stopping accuracy can be obtained.

### BRIEF DESCRIPTION OF THE DRAWINGS

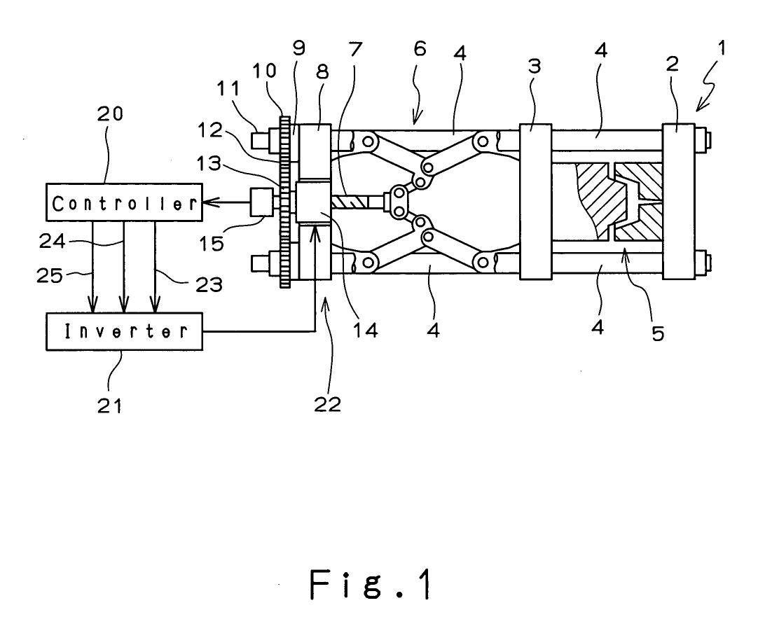

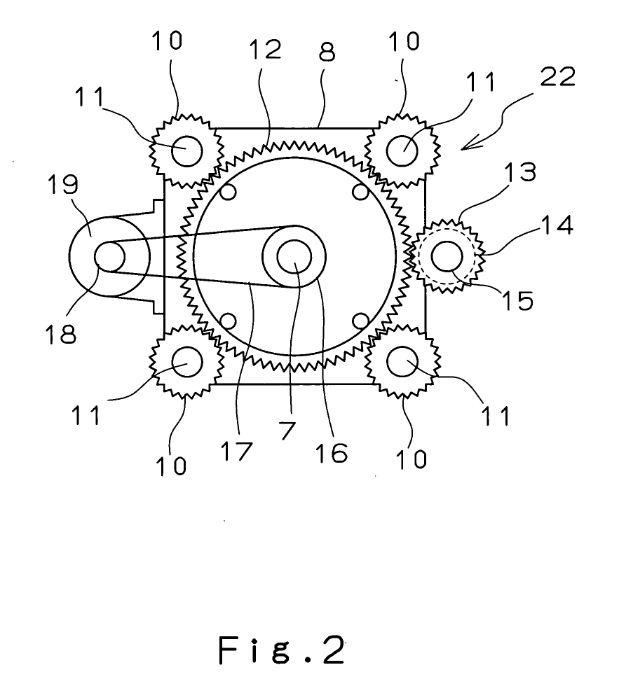

An embodiment of the present invention will be described in detail with reference to the drawings. FIG. 1 is a front view of a clamping device having a die thickness adjusting device to which the present invention is applied. FIG. 2 is a side view of an embodiment of a die thickness adjusting device according to the present invention. FIG. 3 is a graph of a speed command, which shows an embodiment of a control method according to the present invention.

### DETAILED DESCRIPTION OF THE INVENTION

A clamping device 1 is used for an injection molding machine or the like, and opens/closes and clamps a die 5 to which a molten material is injected from an injection device (not shown). The clamping device 1 is composed of a stationary plate 2 and a movable plate 3 to which the die 5 is attached; a plurality of tie rods 4 that are inserted in the periphery of the movable plate 3 and receive a clamping force; a die thickness adjusting device 22 that is provided on the other ends of the tie rods 4 and includes an attachment plate 8 into which a threaded portion 11 is inserted; and a publicly known toggle mechanism 6 that is provided on the opposed surfaces of the attachment plate 8 and the movable plate 3, and generates a clamping force. The toggle mechanism 6 is driven, by a servomotor 19 secured to the back side faces of the attachment plate 8, using a ball screw 7 forwardly or backwardly driven via a gear 18, a belt 17 and a ball nut 16. The toggle mechanism 6 may be replaced with the other mechanism such as a hydraulic cylinder.

The die thickness adjusting device 22 is composed of the attachment plate 8; the threaded portions 11 that penetrate through and project from the four corners of the surface of the attachment plate 8, which is opposed to the surface to which the toggle mechanism 6 is attached; nuts 9 that are engaged with the threaded portions 11 and rotatably provided on the attachment plate 8; gears 10 provided on the outer peripheries of the nuts 9; an annular gear 12 engaged with four gears 10; a drive gear 13 that drives the annular gear 12; an induction motor 14 that is secured on the front side face of the attachment plate 8 and drives the drive gear 13; and an encoder 15 that is connected to the drive gear 13 and detects a position of the die thickness adjusting device 22 functioning as an actuator.

The induction motor 14 is provided with a speed reducer having a ratio of 90:1, but has no brake. The rotation speed of the induction motor 14 is controlled by a general purpose inverter 21 which arbitrarily converts the frequency of three-phase alternating current. A speed command 23, a normal rotation command 24 and a reverse rotation command 25 are transmitted from a controller 20 to the inverter 21. The speed command 23 is an analog voltage signal of 0 to 10 V, and is preset and stored in the controller 20, along with one of the normal rotation command 24 and the reverse rotation command 25 that are alternatively selected in accordance with the speed command 23. The inverter 21 outputs the three phase alternating current, which has a frequency proportional to that of the speed command 23, and a phase sequence in accordance with the normal rotation command 24 or the reverse rotation command 25, to the induction motor 14.

The rotation of the induction motor 14, which has reduced to 1/90 by the speed reducer, is transferred to the drive gear 13. The drive gear 13 rotates the four gears 10 and the four nuts 9 via the annular gear 12. Thus, the die thickness adjusting device 22 is relatively moved in forward-and-backward directions, with respect to the tie rods 4, and along the axes of the rods. Accordingly, the toggle mechanism 6 coupled to the die thickness adjusting device 22, and the movable plate 3 coupled to the toggle mechanism 6 are moved. When the die thickness adjusting device 22 is moved so that a stationary die and a movable die of the die 5 are abutted with each other with the toggle mechanism 6 being extended most by the servomotor 19, the clamping force applied to the die 5 is zero. In this state, after the toggle mechanism 6 is once flexed to slightly open the die 5 as shown in FIG. 1, the die thickness adjusting device 22 is moved toward the die 5 and, then, the toggle mechanism 6 is extended most again. Thus, the tie rods 4 are extended by a distance corresponding to the above displacement of the die thickness adjusting device 22 to generate a tensile force and, accordingly, a clamping force is applied to the die 5.

As described above, the clamping force varies based on an extension amount of the tie rod 4, i.e., a displacement of the die thickness adjusting device 22 with respect to an abutment position of the die 5. The displacement of the die thickness adjusting device 22 depends on the diameter and, length of the tie rod 4. In this embodiment, for example, the displacement is about 2 mm to obtain a clamping force of 110 ton which is a specified value of the clamping device 1. The lead length of the threaded portion 11 is 4 mm, the diameter of the drive gear 13 is substantially identical to that of the gear 10, and the encoder 15 outputs 4096 pulses per one rotation. Accordingly, the displacement of the die thickness adjusting device 22 with respect to the encoder 15 per 1 pulse is about 11 m.

An embodiment of the control method according to the present invention will be described below with reference to FIG. 3. When the die 5 is replaced with a die having a different thickness, the new die 5 is attached to the stationary plate 2 and the movable plate 3 and, then, is set as shown in FIG. 1. As described above, a predetermined position C of the actuator (die thickness adjusting device 22), calculated, by the controller 20, in view of the displacement (clamping-force) of the die thickness adjusting device 22 from an abutment position of the die 5, is set in the controller 20. The controller 20 outputs the normal rotation command 24 or the reverse rotation command 25 along with the speed command 23 to generate a relatively high speed, until the die thickness adjusting device 22 reaches a position A which is a predetermined distance away from the predetermined position C in the backward direction (leftward direction in FIG. 1), in accordance with a relationship between the actual position of the die thickness adjusting device 22 and the predetermined position C.

When the die thickness adjusting device 22 reaches the position A, the controller 20 switches the speed command 23 to a predetermined speed reduction signal 26, to reduce the speed of the die thickness adjusting device 22. The distance between the position A and the predetermined position C is about 1 mm in this embodiment.

When the die thickness adjusting device 22 is sufficiently decelerated and reaches a position B provided between the positions A and C, the controller 20 switches the speed command 23 to an intermittent pulse signal 27 in which pulse-shapes intermittently appear. The distance between the positions B and C is about 0.1 mm in this embodiment. As shown in FIG. 3, in the intermittent pulse signal 27, pulses rise in accordance with an acceleration setting S to allow the pulse to reach a height P after a predetermined time, and instantaneously falls when the actuator is moved a predetermined distance, i.e., the encoder 15 detects a predetermined number of pulses. The center one of pulses shown in FIG. 3 shows a pulse which appears when the actuator is not moved a predetermined distance during an output of the acceleration setting S. This pulse is maintained at the height P and, then, instantaneously falls when the actuator completes to move a predetermined distance. The right one of the pulses shown in FIG. 3 is similar to the left one, but has a peak value higher than that of the left pulse because the time elapsed until the actuator completes to move a predetermined distance is slightly longer than that of the left pulse. Thus, the intermittent pulse signal 27 has a serrated shape having non-uniform shapes of intermittent pulses, and is output until the actuator reaches the predetermined position C at a pulse interval “t”. If the actuator is the die thickness adjusting device in the clamping device having a clamping force of 110 ton according to this embodiment, the pulse height P is set at 10% of a maximum speed, the acceleration setting S is set at 0.1 second, the pulse interval t is set at 50 millisecond, the number of pulses of the encoder 15, corresponding to a predetermined displacement of the actuator is set at 1. However, these numerical values can be changed to any values most suitable for the actuator.

The controller 20 constantly outputs one of the normal rotation command 24 and the reverse rotation command 25 so that the die thickness adjusting device 22 is moved in only a forward direction (rightward direction in FIG. 1) when the intermittent pulse signal 27 is output. Accordingly, an engagement between the nut 9 and the threaded portion 11 is always established when the clamping force is generated even if there is a backlash therebetween. Therefore, no error occurs in a clamping force value when the die thickness adjusting device 22 is positioned at the predetermined position C.

Thus, the die thickness adjusting device 22 which moves in the forward direction, at extremely low speed, is stopped and positioned when the encoder 15 detects the predetermined position C. In this respect, an overrun of the die thickness % adjusting device 22 from the predetermined position C corresponds to 2 to 3 pulses of the pulses in the encoder 15, i.e., 2 to 31 m in this embodiment. This value is remarkably improved in comparison with a value of 101 m in a conventional method.

The above movement of the die thickness adjusting device 22 at an extremely low speed cannot be obtained by the speed command 23 to be output at an extremely small value, due to problems in the properties of the inverter 21, the induction motor 14 or the actuator. Contrary to this, the intermittent pulse signal 27 allows the speed command 23 to be output at a high value to which the inverter 21, the induction motor 14 or the actuator can appropriately respond, even if the high value corresponds to an extremely low speed on average. Thus, the movement of the actuator at an extremely low speed can be easily realized at low cost. As the speed command 23 is switched to the intermittent pulse signal 27 to accomplish the above object, the shape of the intermittent pulse signal 27 is not limited to this embodiment, and the pulse may have several shapes including a general rectangular shape.

The present invention is not limited to the above-described embodiment, and several modifications may be made therein without departing from the gist of the invention. In the above embodiment, for example, the actuator is represented by the die thickness adjusting device 22. However, the present invention can be applied to the actuator other than the die thickness adjusting device 22.

1. A method for controlling an induction motor, in which the speed of the induction motor is controlled, by an inverter, to move and stop an actuator at a predetermined position, wherein
a speed command to be input to the inverter is switched to an intermittent pulse signal when the actuator reaches a position, a predetermined distance before the predetermined position.

2. A method for controlling an induction motor according to claim 1, wherein the intermittent pulse signal has a serrated shape having non-uniform shapes of intermittent pulses, in which the pulses rise at a predetermined time interval in accordance with a predetermined displacement of the actuator.

3. A method for controlling an induction motor according to claim 1, wherein the movement of the actuator in accordance with the intermittent pulse signal is carried out by driving the induction motor in only one rotational direction.

4. A method for controlling an induction motor according to claim 1, wherein the actuator is a die thickness adjusting device in a clamping device of an injection molding machine.
